(19) United States
(12) Patent Application Publication
(10) Pub. No.: US 2025/0145795 A1
(43) Pub. Date: May 8, 2025

(54) OLEFIN/SILANE INTERPOLYMER COMPOSITIONS WITH EXCELLENT THERMAL OXIDATION RESISTANCE

(71) Applicant: Dow Global Technologies LLC, Midland, MI (US)

(72) Inventors: Yabin Sun, Shanghai (CN); Gaoxiang Wu, Houston, TX (US); Colin Li Pi Shan, Pearland, TX (US); Wenxin Zhang, Shanghai (CN)

(21) Appl. No.: 18/719,400

(22) PCT Filed: Dec. 17, 2021
(86) PCT No.: PCT/CN2021/139001

§ 371 Date: Jun. 13, 2024

(51) Int. Cl. C08K 5/134; C08K 5/1545; C08K 5/3492; C08K 5/52; C08L 23/08

(52) U.S. Cl. CPC C08K 5/134; C08K 5/1545; C08K 5/34924; C08K 5/52; C08L 23/0892; C08K 2201/012; C08K 2201/014

(57) ABSTRACT

A process to form a composition, and related composition, the process comprising mixing at least the following components: a) at least one olefin/silane interpolymer comprising at least one Si—H group, and b) at least one hindered phenol selected from Formula H, as described herein.

### BACKGROUND OF THE INVENTION

Heat aging a critical performance feature for polymer composition. Anti-oxidants, such as primary anti-oxidants, like hindered phenols, and secondary anti-oxidants, like phosphites or thioethers, are necessary to improve the thermal oxidative resistance of a polymer formulation. However, there is a need for new polymer compositions, and related processes, which improve thermal oxidative resistance beyond what can be achieved with anti-oxidants.

U.S. Pat. No. 6,624,254 discloses the syntheses of silane functionalized polymers, and polymer conversions through coupling, hydrolysis, hydrolysis and neutralization, condensation, oxidation and hydrosilation (see abstract). This patent discloses a polymer composition containing tris(2,4-di-(tert)-butylphenyl phosphite and tetrakis[methylene(3,5-di-(tert)-butyl-4-hydroxyhydrocinnamate)]methane (see column 31, lines 58-63). See also, U.S. Pat. No. 6,258,902. Silyl-terminated polyolefins and/or silane functionalized polyolefins are disclosed in the following references: U.S. Pat. Nos. 6,075,103; 5,578,690; H. Makio et al., Silanolytic Chain Transfer in Olefin Polymerization with Supported Single-Site Ziegler-Natta Catalysts, Macromolecules, 2001, 34, 4676-4679; S. B. Amin et al., Alkenylsilane Effects on Organotitanium-Catalyzed Ethylene Polymerization Toward Simultaneous Polyolefin Branch and Functional Group Introduction, J. Am. Chem. Soc., 2006, 128, 4506-4507.

U.S. Pat. No. 10,308,829 discloses polymeric compositions comprising a polyolefin having hydrolyzable silane groups, an organic peroxide, and optionally, a catalyst (see abstract) to catalyze hydrolyzation and condensation. A second step crosslinking was observed in the presence of a silanol condensation catalyst (for example, a sulfonic acid or a blocked sulfonic acid) to further link the hydrolysable silane groups in the polymer chain, to generate enhanced crosslinking efficiency. Hydrolyzable silane groups include alkoxy groups, aryloxy groups, aliphatic acyloxy groups, amino or substituted amino groups, and lower alkyl groups (see, for example, column 4, lines 30-49). Polymer compositions may contain one or more additives, including antioxidants (see column 7, lines 36-44).

U.S. Pat. No. 5,741,858 discloses a silane-crosslinked blend comprising the following: a) a polyolefin elastomer with a density less than 0.885 g/cc, b) a crystalline polyolefin, and c) a silane crosslinker (see claim 1). Suitable silanes contain hydrolyzable groups, such as alkoxy groups, aryloxy groups, aliphatic acyloxy groups, amino or substituted amino groups, and lower alkyl groups (see, for example, column 1, lines 44-60). The silane is typically grafted onto the elastomer backbone, thus requiring an additional processing step, prior to crosslinking. The crosslinking of the silane grafted polymers is promoted with a catalyst. Additives used in the preparation of articles include antioxidants (see column 9, lines 59-62). See also U.S. Publication 2019/0225786.

However, there remains a need for new compositions, and related processes, which improve thermal oxidative resistance beyond what can be achieved with anti-oxidants. These needs have been met by the following invention.

### SUMMARY OF THE INVENTION

In a first aspect, a process to form a composition, the process comprising mixing at least the following components:
a) at least one olefin/silane interpolymer comprising at least one Si—H group, and
b) at least one hindered phenol selected from Formula H:

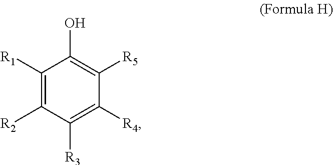

wherein R1 is selected from H, a substituted or unsubstituted hydrocarbyl, or a substituted or unsubstituted heterohydrocarbyl; R2 is selected from H, a substituted or unsubstituted hydrocarbyl, or a substituted or unsubstituted heterohydrocarbyl; R3 is selected from H, a substituted or unsubstituted hydrocarbyl, or a substituted or unsubstituted heterohydrocarbyl; R4 is selected from H, a substituted or unsubstituted hydrocarbyl, or a substituted or unsubstituted heterohydrocarbyl; R5 is selected from H, a substituted or unsubstituted hydrocarbyl, or a substituted or unsubstituted heterohydrocarbyl; and R3 and R4 may optionally form a substituted or unsubstituted hydrocarbylene ring structure, or a substituted or unsubstituted heterohydrocarbylene ring structure; and R2 and R3 may optionally form a substituted or unsubstituted hydrocarbylene ring structure, or a substituted or unsubstituted heterohydrocarbylene ring structure; and wherein at least one of R1 and R5 is a substituted or unsubstituted hydrocarbyl, or a substituted or unsubstituted heterohydrocarbyl.

In a second aspect, a composition comprising at least the following components:
a) at least one olefin/silane interpolymer comprising at least one Si—H group, and
b) at least one hindered phenol selected from Formula H:

### BRIEF DESCRIPTION OF THE DRAWINGS

FIG. 1 depicts a OIT profiles for CE-3 (Si POE AO-2, upper profile, straight line) and for IE-2 (Si POE AO-5, lower profile, dashed line), each as determined by DSC.

### DETAILED DESCRIPTION OF THE INVENTION

Inventive composition, and related processes, have been discovered, as described above, which provide improve thermal oxidative resistance. It has been surprisingly discovered that the inventive compositions provide for an increase in the Oxidative Induction Time (OIT) (indicator of heat aging performance), as compared to similar compositions as discussed below. It has been discovered that there are some synergy effects between SiH group and hindered phenol (AO) to improve the efficiency of AO.

As discussed, in a first aspect, a process to form a composition, the process comprising mixing at least the components a) and b) as described above. In a second aspect, a composition comprising at least the components a) and b) as described above.

An inventive process may comprise a combination of two or more embodiments, as described herein. An inventive composition may comprise a combination of two or more embodiments, as described herein. Each component a and b may comprise a combination of two or more embodiments, as described herein. The following embodiments apply to the first and second aspects of the invention, unless stated otherwise. In reference to the notations used for Formula H, R₁=R1, R₂=R2, R₃=R3, and so forth.

In one embodiment, or a combination of two or more embodiments, each described herein, the composition (C) has an increased Oxidative Induction Time (OIT), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “silane comprising at least one Si—H group,” and wherein the olefin-based polymer has a density that is within ±0.005 g/cc of the density of the interpolymer of component a, and has a melt index (I2) that is within ±0.5 g/10 min of the melt index of the interpolymer of component a; and wherein the OIT is determined by DSC.

In one embodiment, or a combination of two or more embodiments, each described herein, the composition (C) has an increase in OIT that is ≥5.0%, or ≥10%, or ≥11%, or ≥12%, or 14%, or ≥16%, or ≥18%, or ≥19%, or ≥20%, or ≥25%, or 30%, or >35%, or ≥40%, or ≥45%, or ≥50%, or ≥55%, or 60%, or ≥65% greater than the OIT of the similar composition (SC), as determined from the following Equation Y: Increase in OIT (%)=[(OIT(C)−OIT(SC))/OIT(SC)]×100; where “OIT(C)” is the OIT value for the composition and “OIT(SC)” is the OIT value for the similar composition.

In one embodiment, or a combination of two or more embodiments, each described herein, for Formula H, R1 is selected from H, an unsubstituted hydrocarbyl, or an unsubstituted heterohydrocarbyl; R2 is selected from H, or an unsubstituted hydrocarbyl; R3 is selected from H, an unsubstituted hydrocarbyl, or a substituted or unsubstituted heterohydrocarbyl; R4 is selected from H, or a substituted or unsubstituted heterohydrocarbyl; R5 is selected from H, an unsubstituted hydrocarbyl, or a substituted or unsubstituted heterohydrocarbyl; and R3 and R4 may optionally form a substituted or unsubstituted hydrocarbylene ring structure, or a substituted or unsubstituted heterohydrocarbylene ring structure; and R2 and R3 may optionally form a substituted or unsubstituted hydrocarbylene ring structure, or a substituted or unsubstituted heterohydrocarbylene ring structure; and wherein at least one of R1 and R5 is a substituted or unsubstituted hydrocarbyl, or a substituted or unsubstituted heterohydrocarbyl.

In one embodiment, or a combination of two or more embodiments, each described herein, for Formula H, R1 and R5 are each, independently, selected from H, alkyl, substituted alkyl, —CH₂—S-alkyl, —CH₂-phenol, —CH₂-substituted phenol; benzotriazol, substituted benzotriazol, —O-alkyl, or O-substituted alkyl; and further from H, alkyl (for example, methyl, ethyl, propyl, isopropyl, tert-butyl, iso-butyl, tert-amyl, iso-amyl), —CH₂-phenol, benzotriazol, or —O-alkyl; and further from H, methyl, ethyl, propyl, isopropyl, tert-butyl, iso-butyl, tert-amyl or iso-amyl.

In one embodiment, or a combination of two or more embodiments, each described herein, for Formula H, R1 is selected from H, an unsubstituted hydrocarbyl, and further H or an alkyl; R2 is selected from H, an unsubstituted hydrocarbyl, and further H or an alkyl; R4 is selected from H, an unsubstituted hydrocarbyl, and further H or an alkyl; and R5 is selected from H, an unsubstituted hydrocarbyl, and further H or an alkyl.

In one embodiment, or a combination of two or more embodiments, each described herein, Formula H is selected from structures 1) through 50) as follows: 1) 2,6-di-tert-butyl-4-methylphenol; 2) 2-(tert-butyl)-4,6-dimethylphenol; 3) 2-(tert-butyl)-4-ethyl-6-methylphenol; 4) 2-(tert-butyl)-4-isopropyl-6-methylphenol; 5) 2,4-di-tert-butyl-6-methylphenol; 6) 2,4,6-tri-tert-butylphenol; 7) 2,6-di-tert-butyl-4-isopropylphenol; 8) 2,6-di-tert-butyl-4-ethylphenol; 9) 2,6-di-tert-butylphenol; 10) 2-(tert-butyl)-6-methylphenol; 11) 2,6-diisopropyl-4-methylphenol; 12) 2-isopropyl-4,6-dimethylphenol; 13) 4-ethyl-2-isopropyl-6-methylphenol; 14) 2,4-diisopropyl-6-methylphenol; 15) 4-(tert-butyl)-2-isopropyl-6-methylphenol; 16) 2-(tert-butyl)-6-isopropyl-4-methylphenol; 17) 2-(tert-butyl)-4-ethyl-6-isopropylphenol; 18) 2-(tert-butyl)-4,6-diisopropylphenol; 19) 2,4-di-tert-butyl-6-isopropylphenol; 20) 2-(tert-butyl)-4-methyl-6-(tert-pentyl)phenol; 21) 4-methyl-2,6-di-tert-pentylphenol; 22) 2,4-dimethyl-6-(tert-pentyl)phenol; 23) 2-ethyl-4-methyl-6-(tert-pentyl)phenol; 24) 2-(tert-butyl)-6-ethyl-4-methylphenol; 25) 2-ethyl-6-isopropyl-4-methylphenol; 26) 2,6-diethyl-4-methylphenol; 27) octadecyl 3-(3,5-di-tert-butyl-4-hydroxyphenyl)propionate (IRGANOX 1076); 28) pentaerythritol tetrakis-[3-[3,5-di-tert-butyl-4-hydroxyphenyl]propionate (IRGANOX 1010); 29) 1,3,5-tris(3,5-di-tert-butyl-4-hydroxybenzyl)-1,3,5-triazine-2,4,6(1H,3H,5H)-trione (IRGANOX 3114); 30) (1,3,5-trimethyl-2,4,5-tris(3′,5′-ditert-butyl)-4′-hydroxybenzyl)-benzene (IRGANOX 1330); 31) hexamethylene bis[3-(3,5-di-tert-butyl-4-hydroxyphenyl)propionate (IRGANOX 259); 32) benzenepropanoic acid, 3,5-bis(1,1-dimethyl-ethyl)-4-hydroxy-C7-C9 branched alkyl esters (IRGANOX 1135); 33) 3,5-bis(1,1-dimethylethyl)-4-hydroxybenzenepropanoic acid thiodi-2,1-ethanediyl ester (IRGANOX 1035); 34) N,N′-(hexane-1,6-diyl)bis[3-(3,5-di-tert-butyl-4-hydroxyphenyl)propanamide](IRGANOX 1098); 35) 1,2-bis(3,5-di-tert-butyl-4-hydroxy-hydrocinnamoyl)hydrazine (IRGANOX 1024); 36) 2,6-di-tert-butyl-4-(4,6-bis(octylthio)-1,3,5-triazin-2-ylamino) phenol (IRGANOX 565); 37) ethylene bis(oxyethylene) bis-(3-(5-tert-butyl-4-hydroxy-m-tolyl)-propionate) (IRGANOX 245); 38) 4,6-bis(octylthiomethyl)-o-cresol (IRGANOX 1520); 39) 4,6-bis(dodecylthiomethyl)-o-cresol (IRGANOX 1726); 40) 1,3,5-tris(4-(tert-butyl)-3-hydroxy-2,6-dimethylbenzyl)-1,3,5-triazinane-2,4,6-trione (CYANOX 1790); 41) phenol, 2-(5-chloro-2H-bentotriazol-2-yl)-6-(1,1-dimethylethyl)-4-methyl (TINUVIN 326); 42) phenol, 2-(2H-benzotriazol-2-yl)-4-methyl (TINUVIN P); 43) 2-(2H-benzotriazol-2-yl)-4,6-ditertpentylphenol (TINUVIN 328); 44) 2-(2H-benzotriazol-2-yl)-4-(1,1,3,3-tetramethylbutyl)phenol (TINUVIN 329); 45) phenol, 2-(2H-benzotriazol-2-yl)-4-methyl-6-dodecyl (TINUVIN 571); 46) 2,2′-methylenebis(6-(2H-benzotriazol-2-yl)-4-(1,1,3,3-tetramethylbutyl)phenol) (TINUVIN 360); 47) 2-(4,6-diphenyl-1,3,5-triazin-2-yl)-5-[(hexyl)oxy]-phenol (TINUVIN 1577); 48) 2-(2H-benzotriazol-2-yl)-4,6-bis(1-methyl-1-phenylethyl)phenol (TINUVIN 234); 49) 4,4″-thiobis(2-tert-butyl-5-methylphenol (TBM-6); or 50) 3,4-dihydro-2,5,7,8-tetramethyl-2-(4,8,12-trimethyltridecyl)-2H-1-benzopyran-6-ol (IRGANOX E201).

In one embodiment, or a combination of two or more embodiments, each described herein, the olefin/silane interpolymer of component a is an ethylene/silane interpolymer, or an ethylene/alpha-olefin/silane interpolymer, or an ethylene/alpha-olefin/silane terpolymer. In one embodiment, or a combination of two or more embodiments, each described herein, the alpha-olefin of the ethylene/alpha-olefin/silane interpolymer or terpolymer, is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.

In one embodiment, or a combination of two or more embodiments, each described herein, the olefin/silane interpolymer of component a comprises, in polymerized form, ≥0.10 wt %, or ≥0.20 wt %, or ≥0.40 wt %, or ≥0.60 wt %, or ≥0.80 wt %, or ≥1.0 wt %, or ≥1.2 wt %, or ≥1.3 wt %, or ≥1.4 wt %, or ≥1.5 wt % of the silane, based on the weight of the interpolymer. In one embodiment, or a combination of two or more embodiments, each described herein, the interpolymer of component a comprises, in polymerized form, <40 wt %, or ≤30 wt %, or 20 wt %, or ≤10 wt %, or ≤8.0 wt %, or ≤6.0 wt %, or ≤5.0 wt %, or ≤4.5 wt %, or ≤4.0 wt % of the silane, based on the weight of the interpolymer.

In one embodiment, or a combination of two or more embodiments, each described herein, the olefin/silane interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc, or ≥0.868 g/cc, or ≥0.869 g/cc, or ≥0.870 g/cc (1 cc=1 cm³). In one embodiment, or a combination of two or more embodiments, each described herein, the interpolymer of component a has a density ≤0.940 g/cc, or ≤0.930 g/cc, or ≤0.920 g/cc, or ≤0.910 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.881 g/cc, or ≤0.880 g/cc, or ≤0.879 g/cc.

In one embodiment, or a combination of two or more embodiments, each described herein, the olefin/silane interpolymer of component a has a melt index (I2)≥0.2 g/10 min, or ≥0.5 g/10 min, or ≥0.6 g/10 min, or ≥0.7 g/10 min, or ≥0.8 g/10 min. In one embodiment, or a combination of two or more embodiments, each described herein, the interpolymer of component a has a melt index (I2)≤100 g/10 min, or ≤50 g/10 min, or ≤20 g/10 min, or ≤18 g/10 min, or ≤16 g/10 min, or ≤14 g/10 min, or ≤12 g/10 min, or ≤10 g/10 min, or ≤8.0 g/10 min, or ≤6.0 g/10 min, or ≤4.0 g/10 min, or ≤2.0 g/10 min, or ≤1.0 g/10 min.

In one embodiment, or a combination of two or more embodiments, each described herein, the weight ratio of component a to component b is ≥200, or ≥220, or ≥240, or ≥260, or ≥280, or ≥300 or ≥310, or ≥320 or ≥330. In one embodiment, or a combination of two or more embodiments, each described herein, the weight ratio of component a to component b is ≤1000 or ≤900, or ≤800, or ≤780 or ≤760, or ≤740, or ≤720, or ≤700, or ≤680, or ≤670.

In one embodiment, or a combination of two or more embodiments, each described herein, the process further comprises thermally treating the components during the mixing or after the mixing, and further at a temperature ≥40° C., or ≥50° C., or ≥60° C., or ≥70° C., or ≥80° C., or ≥90° C., or ≥95° C., or ≥100° C., or ≥105° C., or ≥110° C. In one embodiment, or a combination of two or more embodiments, each described herein, the process further comprises thermally treating the components during the mixing or after the mixing, and further at a temperature ≤190° C., or ≤180° C., or ≤170° C., or ≤160° C., or ≤150° C., or ≤140° C., or 130° C., or 120° C., or ≤115° C.

Also provided is a composition formed by the process of one embodiment, or a combination of two or more embodiments, each described herein.

Also provided is a blend composition comprising the composition of one embodiment, or a combination of two or more embodiments, each described herein, and comprising a thermoplastic polymer different from the olefin/silane interpolymer of component a in one or more features, such as monomer(s) types, monomer(s) amounts, monomer(s) distributions, density, melt index (I2), Mn, Mw, MWD, or any combination thereof.

Also provided is an article comprising at least one component formed a composition of one embodiment, or a combination of two or more embodiments, each described herein.

### Silane Monomer

A silane monomer, as used herein, comprises at least one (type) Si—H group. In one embodiment, the silane monomer is selected from Formula 1, as discussed herein. Some examples of silane monomers include hexenylsilane, allylsilane, vinylsilane, octenylsilane, hexenyldimethylsilane, octenyldimethylsilane, vinyldimethylsilane, vinyldiethylsilane, vinyldi(n-butyl)silane, vinylmethyloctadecylsilane, vinyidiphenylsilane, vinyldibenzylsilane, allyldimethylsilane, allyldiethylsilane, allyldi(n-butyl)silane, allylmethyloctadecylsilane, allyldiphenylsilane, bishexenylsilane, and allyidibenzylsilane. Mixtures of the foregoing alkenylsilanes may also be used. More specific examples of silane monomers are described herein.

### Anti-Oxidants

An antioxidant protects the composition from degradation, typically caused by reaction with oxygen and induced by such things as heat, light, or residual catalyst from a raw material. Suitable antioxidants include hindered phenols and multifunctional phenols such as sulfur and phosphorous containing phenols. Representative hindered phenols include, but are not limited to, 1,3,5-trimethyl-2,4,6-tris-(3,5-di-tertbutyl-4-hydroxybenzyl)-benzene; pentaerythrityl tetrakis-3(3,5-d i-tert-butyl-4-hydroxyphenyl)-propionate; n-octadecyl-3(3,5-di-tert-butyl-4-hydroxyphenyl)-propionate; 4,4′-methylenebis-(2,6-tertbutyl-phenol); 4,4′-thiobis-(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl-3,5-di-tert-buryl-4-hydroxy-benzoate; and sorbitolhexa-[3-(3,5-di-tert-butyl-4-hydroxy-phenyl)-propionate]. Such antioxidants are commercially available from Ciba Specialty Chemicals and include IRGANOX 565, 1010, 1076 and 1726, which are hindered phenols. See also structures 1)-50), each shown above.

Representative hindered amines include but not limited to bis(2,2,6,6,-tetramethyl-4-piperidyl)sebaceate, Bis (1,2,2,6,6-pentamethyl-4-piperidinyl)-2-butyl-2-(4-hy-droxy-3,5-di-tert.-butylbenzyl) propanedioate, ester between decanedioic acid and bis(2,2,6,6-tetrameth-yl-1-(octyloxy)-4-piperidinyl), Poly-(N-ß-hydroxyethyl-2,2,6,6-te-tramethyl-4-hydroxy-piperidyl succinate), N,N′-Bis(2,2,6,6-tetramethyl-4-piper-idyl)-N,N′-diformylhexam-ethylenediamine, N,N′-Bis(2,2,6,6-tetramethyl-4-piper-idinyl)-1,3-benzenedicarboxamide, 2,2,6,6-Tetramethyl-4-piper-idinyl stearate etc. Arylamine, representative arylamine include but not limited to, 4,4′-bis (alpha, alpha-dimethylbenzyl) diphenylamine, N1-(4-methylpentan-2-yl)-N4-phenylbenzene-1,4-diamine, N,N′-diphenyl-p-phenylenediamine, di([1,1′-biphenyl]-4-yl)amine, (2,2,4-trimethyl-1,2-dihydroquinoline), 9,9-Dimethyl-9,10-dihydroacridine, N-Phenyl-2-naphthylamine, N1,N4-di(naphthalen-2-yl)benzene-1,4-diamine, N,N′-Bis-(1,4-Dimethylpentyl)-P-Phenylenediamine, N,N′-di-sec-butyl-1,4-phenylenediamine, N-Isopropyl-N′-phenyl-1,4-phenylenediamine, 6-Ethoxy-2,2,4-trimethyl-1,2-dihydroquinoline. Hydroxyl amine, representative hydroxylamine is but not limited to, N,N-dioctadecylhydroxylamine. These primary antioxidants act as hydrogen donor to active oxyl radicals, and may be used alone, or in combinations of themselves or in combination with secondary antioxidants, such as a phosphite antioxidant, like IRGAFOS 168, available from BASF, or such as thioester, like IRGANOX PS802 or IRGANOX PS800, each available from BASF.

### Additives

An inventive composition may comprise one or more additional additives. Additives include, but are not limited to, fillers, scorch retardants, tackifiers, waxes, compatibilizers, adhesion promoters, plasticizers (for example, oils), blocking agents, antiblocking agents, anti-static agents, release agents, anti-cling additives, colorants, dyes, pigments, and combinations thereof.

### Definitions

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter.

Trace amounts of impurities, such as catalyst residues, can be incorporated into and/or within the polymer. Typically, a commercial polymer is stabilized with very low amounts (“ppm” amounts) of one or more stabilizers.

The term “interpolymer,” as used herein, refers to polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, at least 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, at least 50 wt % or a majority weight percent of ethylene (based on the weight of the polymer), and optionally may comprise one or more comonomers.

The term “ethylene/alpha-olefin interpolymer,” as used herein, refers to a random interpolymer that comprises, in polymerized form, at least 50 wt % or a majority weight percent of ethylene (based on the weight of the interpolymer), and an alpha-olefin.

The term, “ethylene/alpha-olefin copolymer,” as used herein, refers to a random copolymer that comprises, in polymerized form, at least 50 wt % or a majority weight percent of ethylene (based on the weight of the copolymer), and an alpha-olefin, as the only two monomer types.

The term “olefin multi-block interpolymer,” as used herein, refers to an interpolymer that is characterized by multiple blocks or segments of two or more polymerized monomer units, differing in chemical or physical properties. In some embodiments, the multi-block interpolymers can be represented by the following formula: (AB)n, where n is at least 1, preferably an integer greater than 1, such as 2, 3, 4, 5, 10, 15, 20, 30, 40, 50, 60, 70, 80, 90, 100, or higher. Here, “A” represents a hard block or segment, and “B” represents a soft block or segment. Preferably the A segments and the B segments are linked in a substantially linear fashion, as opposed to a substantially branched or substantially star-shaped fashion. Preferably, the A segments and the B segments are randomly distributed along the polymer chain. These multi block interpolymers, in general, are produced via a chain shuttling process, such as, for example, described in U.S. Pat. No. 7,858,706, which is herein incorporated by reference. See also U.S. Pat. Nos. 9,243,173; 7,608,668; 7,893,166; 7,947,793; and U.S. Publication 2020/0197880; all incorporated herein by reference. The interpolymer comprises, in polymerized form, at least 50 wt % or a majority weight percent of an olefin, such as ethylene or propylene (based on the weight of the multi-block interpolymer), and one or more comonomers.

The term “ethylene/alpha-olefin multi-block interpolymer,” as used herein, refers to an interpolymer that is characterized by multiple blocks or segments of two or more polymerized monomer units, differing in chemical or physical properties, as described above for olefin multi-block interpolymer. The ethylene/alpha-olefin multi-block interpolymer comprises, in polymerized form, at least 50 wt % or a majority weight percent of ethylene (based on the weight of the multi-block interpolymer), and an alpha-olefin.

The term “ethylene/alpha-olefin multi-block copolymer,” as used herein, refers to a copolymer that is characterized by multiple blocks or segments of two polymerized monomer units, differing in chemical or physical properties, as described above for olefin multi-block interpolymer. The ethylene/alpha-olefin multi-block copolymer comprises, in polymerized form, at least 50 wt % or a majority weight percent of ethylene (based on the weight of the multi-block copolymer), and an alpha-olefin, as the only two monomer types.

The term “olefin/silane interpolymer,” as used herein, refers to a random interpolymer that comprises, in polymerized form, at least 50 wt % or a majority weight percent of an olefin (based on the weight of the interpolymer), and a silane monomer. As used herein, the interpolymer comprises at least one Si—H group, and the phrase “at least one Si—H group” refers to a type of “Si—H” group. It is understood in the art that the interpolymer would contain a multiple number of these groups. The olefin/silane interpolymer is formed by the copolymerization (for example, using a bis-biphenyl-phenoxy metal complex (or a bis-biphenyloxy metal complex)) of at least the olefin and the silane monomer. An example of a silane monomer is depicted in Formula 1, as described herein.

The term “ethylene/silane interpolymer,” as used herein, refers to a random interpolymer that comprises, in polymerized form, at least 50 wt % or a majority weight percent of ethylene (based on the weight of the interpolymer), and a silane monomer. As used herein, the interpolymer comprises at least one Si—H group, as discussed above. The ethylene/silane interpolymer is formed by the copolymerization of at least the ethylene and the silane monomer.

The term “ethylene/alpha-olefin/silane interpolymer,” as used herein, refers to a random interpolymer that comprises, in polymerized form, at least 50 wt % or a majority weight percent of ethylene (based on the weight of the interpolymer), an alpha-olefin and a silane monomer. As used herein, these interpolymer comprises at least one Si—H group, as discussed above. The ethylene/silane interpolymer is formed by the copolymerization of at least the ethylene, the alpha-olefin and the silane monomer.

The term “ethylene/alpha-olefin/silane terpolymer,” as used herein, refers to a random terpolymer that comprises, in polymerized form, at least 50 wt % or a majority weight percent of ethylene (based on the weight of the terpolymer), an alpha-olefin and a silane monomer as the only three monomer types. As used herein, the terpolymer comprises at least one Si—H group, as discussed above. The ethylene/silane terpolymer is formed by the copolymerization of the ethylene, the alpha-olefin and the silane monomer.

The term “heteroatom,” refers to an atom other than hydrogen or carbon (for example, O, N or P). The term “heteroatom group” refers to a heteroatom or to a chemical group containing one or more heteroatoms.

The terms “hydrocarbon,” “hydrocarbyl,” and similar terms, as used herein, refer to a respective compound or chemical group, etc., containing only carbon and hydrogen atoms. A divalent “hydrocarbylene group” is defined in similar manner.

The terms “heterohydrocarbon,” “heterohydrocarbyl,” and similar terms, as used herein, refer to a respective hydrocarbon,” or “hydrocarbyl group, etc., in which at least one carbon atom is substituted with a heteroatom group (for example, O, N, S or P). The monovalent heterohydrocarbyl group may be bonded to the remaining compound of interest via a carbon atom or via a heteroatom. A divalent “heterohydrocarbylene” is defined in similar manner; and the divalent heterohydrocarbylene group may be bonded to the remaining compound of interest via two carbon atoms, or two heteroatoms, or a carbon atom and a heteroatom.

The terms “substituted hydrocarbon,” “substituted hydrocarbyl,” and similar terms, as used herein, refer to a respective hydrocarbon or hydrocarbyl group, etc., in which one or more hydrogen atoms is/are independently substituted with a heteroatom group.

The terms “substituted heterohydrocarbon,” “substituted heterohydrocarbyl,” and similar terms, as used herein, refer to a respective heterohydrocarbon or heterohydrocarbyl group, etc., in which one or more hydrogen atoms is/are independently substituted with a heteroatom group.

The term “hydrocarbylene ring structure,” and similar terms, as used herein in reference to Formula H, refer to a ring structure containing only carbon and hydrogen atoms, and which structure is bonded (via two carbon atoms) to the “phenyl ring” of Formula H, at two respective adjacent carbon atoms within the “phenyl ring” of Formula H.

The term “heterohydrocarbylene ring structure,” and similar terms, as used herein in reference to Formula H, refer to a hydrocarbylene ring structure, in which at least one carbon atom is substituted with a heteroatom group (for example, O, N, S or P), and which structure is bonded (via two carbon atoms, two heteroatoms, or a carbon atom and a heteroatom) to the “phenyl ring” of Formula H, at two respective adjacent carbon atoms within the “phenyl ring” of Formula H. See for example, IRGANOX E201 (structure 50).

The terms “substituted hydrocarbylene ring structure,” and similar terms, as used herein, refer to a hydrocarbylene ring structure, in which one or more hydrogen atoms is/are independently substituted with a heteroatom group.

The terms “substituted heterohydrocarbylene ring structure,” and similar terms, as used herein, refer to a heterohydrocarbylene ring structure, in which one or more hydrogen atoms is/are independently substituted with a heteroatom group.

For other more specific chemical groups, the term “substituted” is similarly defined as discussed above for substituted hydrocarbon, substituted heterohydrocarbon, and other terms.

The terms “thermally treating,” “thermal treatment,” and similar terms, as used herein, in reference to a composition comprising an olefin/silane interpolymer, refer to the application of heat to the composition. Heat may be applied by electrical means (for example, a heating coil) and/or by radiation and/or by hot oil and/or by mechanical shearing. Note, the temperature at which the thermal treatment takes place, refers to the temperature of the composition (for example, the melt temperature of the composition).

The term “alkenyl group,” as used herein, refers to an organic chemical group that contains at least one carbon-carbon double bond (C═C). In a preferred embodiment, the alkenyl group is a hydrocarbon group containing at least one carbon-carbon double bond, and further containing only one carbon-carbon double bond.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation, any other component, step or procedure, excepting those that are not essential to operability. The term “consisting of” excludes any component, step or procedure, not specifically delineated or listed.

### Listing of Some Processes and Compositions

A] A process to form a composition, the process comprising mixing at least the following components:
a) at least one olefin/silane interpolymer comprising at least one Si—H group, and
b) at least one hindered phenol selected from Formula H:

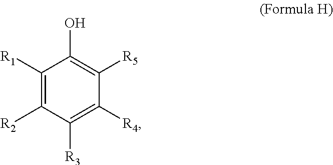

wherein R1 is selected from H, a substituted or unsubstituted hydrocarbyl, or a substituted or unsubstituted heterohydrocarbyl; R2 is selected from H, a substituted or unsubstituted hydrocarbyl, or a substituted or unsubstituted heterohydrocarbyl; R3 is selected from H, a substituted or unsubstituted hydrocarbyl, or a substituted or unsubstituted heterohydrocarbyl; R4 is selected from H, a substituted or unsubstituted hydrocarbyl, or a substituted or unsubstituted heterohydrocarbyl; R5 is selected from H, a substituted or unsubstituted hydrocarbyl, or a substituted or unsubstituted heterohydrocarbyl; and R3 and R4 may optionally form a substituted or unsubstituted hydrocarbylene ring structure, or a substituted or unsubstituted heterohydrocarbylene ring structure; and R2 and R3 may optionally form a substituted or unsubstituted hydrocarbylene ring structure, or a substituted or unsubstituted heterohydrocarbylene ring structure; and wherein at least one of R1 and R5 is a substituted or unsubstituted hydrocarbyl, or a substituted or unsubstituted heterohydrocarbyl. Further component a comprises one olefin/silane interpolymer comprising at least one Si—H group.
B] The process of any one of A] above, wherein the composition (C) has an increased Oxidative Induction Time (OIT), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “silane comprising at least one Si—H group,” and wherein the olefin-based polymer has a density that is within ±0.005 g/cc of the density of the interpolymer of component a, and has a melt index (I2) that is within ±0.5 g/10 min of the melt index of the interpolymer of component a; and wherein the OIT is determined by DSC.
C] The process of B] above, wherein the composition (C) has an increase in OIT that is ≥5.0%, or ≥10%, or ≥11%, or ≥12%, or 14%, or ≥16%, or ≥18%, or ≥19%, or ≥20%, or ≥25%, or 30%, or ≥35%, or ≥40%, or ≥45%, or ≥50%, or ≥55%, or 60%, or ≥65% greater than the OIT of the similar composition (SC), as determined from the following Equation Y: Increase in OIT (%)=[(OIT(C)−OIT(SC))/OIT(SC)]×100; where “OIT(C)” is the OIT value for the composition and “OIT(SC)” is the OIT value for the similar composition.
D] The process of any one of A]-C](A]through C]) above, wherein for Formula H, R1 is selected from H, an unsubstituted hydrocarbyl, or an unsubstituted heterohydrocarbyl; R2 is selected from H, or an unsubstituted hydrocarbyl; R3 is selected from H, an unsubstituted hydrocarbyl, or a substituted or unsubstituted heterohydrocarbyl; R4 is selected from H, or a substituted or unsubstituted heterohydrocarbyl; R5 is selected from H, an unsubstituted hydrocarbyl, or a substituted or unsubstituted heterohydrocarbyl; and R3 and R4 may optionally form a substituted or unsubstituted hydrocarbylene ring structure, or a substituted or unsubstituted heterohydrocarbylene ring structure; and R2 and R3 may optionally form a substituted or unsubstituted hydrocarbylene ring structure, or a substituted or unsubstituted heterohydrocarbylene ring structure; and wherein at least one of R1 and R5 is a substituted or unsubstituted hydrocarbyl, or a substituted or unsubstituted heterohydrocarbyl.
E] The process of any one of A]-D] above, wherein for Formula H, R1 and R5 are each, independently, selected from H, alkyl, substituted alkyl, —CH₂—S-alkyl, —CH₂-phenol, —CH₂— substituted phenol; benzotriazol, substituted benzotriazol, —O-alkyl, or O-substituted alkyl; and further from H, alkyl (for example, methyl, ethyl, propyl, isopropyl, tert-butyl, iso-butyl, tert-amyl, iso-amyl), —CH₂-phenol, benzotriazol, or —O-alkyl; and further from H, methyl, ethyl, propyl, isopropyl, tert-butyl, iso-butyl, tert-amyl or iso-amyl.
F] The process of any one of A]-E] above, wherein for Formula H, R1 is selected from H, an unsubstituted hydrocarbyl, and further H or an alkyl; R2 is selected from H, an unsubstituted hydrocarbyl, and further H or an alkyl; R4 is selected from H, an unsubstituted hydrocarbyl, and further H or an alkyl; and R5 is selected from H, an unsubstituted hydrocarbyl, and further H or an alkyl.
G] The process of any one of A]-F] above, wherein for Formula H, R2=R4, and further R1=R5.
H] The process of any one of A]-G] above, wherein Formula H is selected from structures 1) through 50), each as described herein, and further from structures 27), 28), 37), 40), 49) or 50), each as described herein.
I] The process of any one of A]-H] above, wherein the process further comprises thermally treating the components during the mixing or after the mixing, and further at a temperature ≥40° C., or ≥50° C., or ≥60° C., or ≥70° C., or ≥80° C., or ≥90° C., or ≥95° C., or ≥100° C., or ≥105° C., or ≥110° C.
J] The process of any one of A]-I] above, wherein the process further comprises thermally treating the components during the mixing or after the mixing, and further at a temperature ≤190° C., or ≤180° C., or ≤170° C., or ≤160° C., or ≤150° C., or ≤140° C., or ≤130° C., or 120° C., or 115° C.
K] The process of any one of A]-J] above, wherein the olefin/silane interpolymer of component a is an ethylene/silane interpolymer, or an ethylene/alpha-olefin/silane interpolymer, and or an ethylene/alpha-olefin/silane terpolymer.
L] The process of K] above, wherein the alpha-olefin of the ethylene/alpha-olefin/silane interpolymer or terpolymer is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
M] The process of any one of A]-L] above, wherein the olefin/silane interpolymer of component a comprises, in polymerized form, ≥0.10 wt %, or ≥0.20 wt %, or ≥0.40 wt %, or ≥0.60 wt %, or ≥0.80 wt %, or ≥1.0 wt %, or ≥1.2 wt %, or ≥1.3 wt %, or ≥1.4 wt %, or ≥1.5 wt % of the silane, based on the weight of the interpolymer.
N] The process of any one of A]-M] above, wherein the interpolymer of component a comprises, in polymerized form, ≤40 wt %, or 30 wt %, or ≤20 wt %, or ≤10 wt %, or ≤8.0 wt %, or ≤6.0 wt %, or ≤5.0 wt %, or ≤4.5 wt %, or ≤4.0 wt % of the silane, based on the weight of the interpolymer.
O] The process of any one of A]-N] above, wherein the olefin/silane interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc, or ≥0.868 g/cc, or ≥0.869 g/cc, or ≥0.870 g/cc.
P] The process of any one of A]-O] above, wherein the interpolymer of component a has a density ≤0.940 g/cc, or ≤0.930 g/cc, or ≤0.920 g/cc, or ≤0.910 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.881 g/cc, or ≤0.880 g/cc, or ≤0.879 g/cc.
Q] The process of any one of A]-P] above, wherein the interpolymer of component a has a melt index (I2)≥0.2 g/10 min, or ≥0.5 g/10 min, or ≥0.6 g/10 min, or ≥0.7 g/10 min, or ≥0.8 g/10 min.
R] The process of any one of A]-Q] above, wherein the interpolymer of component a has a melt index (I2)≤100 g/10 min, or ≤50 g/10 min, or 20 g/10 min, or ≤18 g/10 min, or ≤16 g/10 min, or ≤14 g/10 min, or ≤12 g/10 min, or ≤10 g/10 min, or ≤8.0 g/10 min, or ≤6.0 g/10 min, or ≤4.0 g/10 min, or ≤2.0 g/10 min, or ≤1.0 g/10 min.
S] A composition formed by the process of any one of A]-R] above.
T] A composition comprising at least the following components:
a) at least one olefin/silane interpolymer comprising at least one Si—H group, and
b) at least one hindered phenol selected from Formula H as described above (see A]).
   U] The composition of T] above, wherein component a comprises one olefin/silane interpolymer comprising at least one Si—H group.
   V] The composition of T] or U] above, wherein the composition (C) has an increased Oxidative Induction Time (OIT), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “silane comprising at least one Si—H group,” and wherein the olefin-based polymer has a density that is within ±0.005 g/cc of the density of the interpolymer of component a, and has a melt index (I2) that is within ±0.5 g/10 min of the melt index of the interpolymer of component a; and wherein the OIT is determined by DSC.
   W] The composition of V] above, wherein the composition (C) has an increase in OIT that is ≥5.0%, or ≥10%, or ≥11%, or ≥12%, or 14%, or ≥16%, or ≥18%, or ≥19%, or ≥20%, or ≥25%, or 30%, or ≥35%, or ≥40%, or ≥45%, or ≥50%, or ≥55%, or 60%, or ≥65% greater than the OIT of the similar composition (SC), as determined from the following Equation Y: Increase in OIT (%)=[(OIT(C)−OIT(SC))/OIT(SC)]×100; where “OIT(C)” is the OIT value for the composition and “OIT(SC)” is the OIT value for the similar composition.
   X] The composition of any one of T]-W] above, wherein for Formula H, R1 is selected from H, an unsubstituted hydrocarbyl, or an unsubstituted heterohydrocarbyl; R2 is selected from H, or an unsubstituted hydrocarbyl; R3 is selected from H, an unsubstituted hydrocarbyl, or a substituted or unsubstituted heterohydrocarbyl; R4 is selected from H, or a substituted or unsubstituted heterohydrocarbyl; R5 is selected from H, an unsubstituted hydrocarbyl, or a substituted or unsubstituted heterohydrocarbyl; and R3 and R4 may optionally form a substituted or unsubstituted hydrocarbylene ring structure, or a substituted or unsubstituted heterohydrocarbylene ring structure; and R2 and R3 may optionally form a substituted or unsubstituted hydrocarbylene ring structure, or a substituted or unsubstituted heterohydrocarbylene ring structure; and wherein at least one of R1 and R5 is a substituted or unsubstituted hydrocarbyl, or a substituted or unsubstituted heterohydrocarbyl.
   Y] The composition of any one of T]-X] above, wherein, for Formula H, R1 and R5 are each, independently, selected from H, alkyl, substituted alkyl, —CH₂—S-alkyl, —CH₂-phenol, —CH₂-substituted phenol; benzotriazol, substituted benzotriazol, —O-alkyl, or O-substituted alkyl; and further from H, alkyl (for example, methyl, ethyl, propyl, isopropyl, tert-butyl, iso-butyl, tert-amyl, iso-amyl), —CH₂-phenol, benzotriazol, or —O-alkyl; and further from H, methyl, ethyl, propyl, isopropyl, tert-butyl, iso-butyl, tert-amyl or iso-amyl.
   Z] The composition of any one of T]-Y] above, wherein, for Formula H, R1 is selected from H, an unsubstituted hydrocarbyl, and further H or an alkyl; R2 is selected from H, an unsubstituted hydrocarbyl, and further H or an alkyl; R4 is selected from H, an unsubstituted hydrocarbyl, and further H or an alkyl; and R5 is selected from H, an unsubstituted hydrocarbyl, and further H or an alkyl.
   A2] The composition of any one of T]-Z] above, wherein for Formula H, R2=R4, and further R1=R5.
   B2] The composition of any one of T]-A2] above, wherein Formula H is selected from structures 1) through 50), each as described herein, and further from structures 27), 28), 37), 40), 49) or 50), each as described herein.
   C2] The composition of any one of T]-B2] above, wherein the olefin/silane interpolymer of component a is an ethylene/silane interpolymer, or an ethylene/alpha-olefin/silane interpolymer, or an ethylene/alpha-olefin/silane terpolymer.
   D2] The composition of C2] above, wherein the alpha-olefin of the ethylene/alpha-olefin/silane interpolymer or terpolymer is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
   E2] The composition of any one of T]-D2] above, wherein the olefin/silane interpolymer of component a comprises, in polymerized form, ≥0.10 wt %, or ≥0.20 wt %, or ≥0.40 wt %, or ≥0.60 wt %, or ≥0.80 wt %, or ≥1.0 wt %, or ≥1.2 wt %, or ≥1.3 wt %, or ≥1.4 wt %, or ≥1.5 wt % of the silane, based on the weight of the interpolymer.
   F2] The composition of any one of T]-E2] above, wherein the interpolymer of component a comprises, in polymerized form, ≤40 wt %, or ≤30 wt %, or ≤20 wt %, or ≤10 wt %, or ≤8.0 wt %, or ≤6.0 wt %, or ≤5.0 wt %, or ≤4.5 wt %, or ≤4.0 wt % of the silane, based on the weight of the interpolymer.
   G2] The composition of any one of T]-F2] above, wherein the olefin/silane interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc, or ≥0.868 g/cc, or ≥0.869 g/cc, or ≥0.870 g/cc.
   H2] The composition of any one of T]-G2] above, wherein the interpolymer of component a has a density ≤0.940 g/cc, or ≤0.930 g/cc, or ≤0.920 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.881 g/cc, or ≤0.880 g/cc, or ≤0.879 g/cc.
   I2] The composition of any one of T]-H2] above, wherein the olefin/silane interpolymer of component a has a melt index (I2)≥0.2 g/10 min, or ≥0.5 g/10 min, or ≥0.6 g/10 min, or ≥0.7 g/0 min, or ≥0.8 g/10 min.
   J2] The composition of any one of T]-I2] above, wherein the interpolymer of component a has a melt index (I2)≤100 g/10 min, or ≤50 g/10 min, or ≤20 g/10 min, or ≤18 g/10 min, or ≤16 g/10 min, or ≤14 g/10 min, or ≤12 g/10 min, or ≤10 g/10 min, or ≤8.0 g/10 min, or ≤6.0 g/10 min, or ≤4.0 g/10 min, or ≤2.0 g/10 min, or ≤1.0 g/10 min.
   A3] The process of any one of A]-R] above, or composition of any one of S] or T]-J2]above, wherein the hindered phenol of component b has a molecular weight ≥50 g/mole, or ≥100 g/mole, or ≥150 g/mole, or ≥200 g/mole, or ≥250 g/mole, or ≥300 g/mole, or ≥350 g/mole and/or ≤2000 g/mole, or ≤1800 g/mole, or ≤1600 g/mole, or ≤1400 g/mole, or ≤1200 g/mole.
   B3] The process of any one of A]-R], or A3] above, or the composition of any one of S], T]-J2] or A3] above, wherein the silane of the olefin/silane interpolymer (of component a) is derived from a silane monomer selected from Formula 1:

A-(SiBC-O)ₓ—Si-EFH (Formula 1),

where A is an alkenyl group,
B is a hydrocarbyl group or hydrogen, C is a hydrocarbyl group or hydrogen, and where B and C may be the same or different;
H is hydrogen, and x≥0;
E is a hydrocarbyl group or hydrogen, F is a hydrocarbyl group or hydrogen, and where E and F may be the same or different.
   C3] The process of B3] above, or the composition of B3] above, wherein for Formula 1, x is from 0 to 10, or from 0 to 8, or from 0 to 6, or from 0 to 4, or from 0 to 2, or 0 or 1, or 0.
   D3] The process of B3] or C3] above, or the composition of B3] or C3] above, wherein, for Formula 1, A is a C2-C50 alkenyl group, or a C2-C40 alkenyl group, or a C2-C30 alkenyl group, or a C2-C20 alkenyl group.
   E3] The process of any one of B3]-D3] above, or composition of any one of B3]-D3]above, wherein, for Formula 1, A is selected from the following structures i)-iv):
i) R¹R²C═CR³—, where each of R¹, R² is independently hydrogen or an alkyl group, and R³ is hydrogen, and wherein R¹ and R² may be the same or different;
ii) R¹R²C═CR³—(CR⁴R⁵)ₙ—, where each of R¹, R², R⁴, R⁵ is independently hydrogen, or an alkyl group, and R³ is hydrogen, and wherein two or more from R¹, R², R⁴, R⁵ may be the same or different, and n is from 1 to 10, or 1 to 8, or 1 to 6, or 1 to 4, or 1 to 2, or 1;
iii)

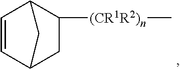

where each of R¹ and R² is independently hydrogen or an alkyl group, and wherein R¹, and R² may be the same or different, and n is from 1 to 10, or 1 to 8, or 1 to 6, or 1 to 4, or 1 to 2, or 1; or
iv)

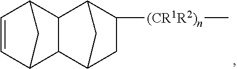

where each of R¹ and R² is independently hydrogen or an alkyl group, and wherein R¹, and R² may be the same or different, and n is from 1 to 10, or 1 to 8, or 1 to 6, or 1 to 4, or 1 to 2, or 1.
F3] The process of any one of B3]-E3] above, or the composition of any one of B3]-E3]above, wherein, for Formula 1, A is selected from the following structures i)-iv):
i) H₂C═CH—;
ii) H₂C═CH—(CH₂)ₙ—, where n is from 1 to 10, or 1 to 8, or 1 to 6, or 1 to 4, or 1 to 2, or 1;
iii)

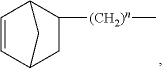

where n is from 1 to 10, or 1 to 8, or 1 to 6, or 1 to 4, or 1 to 2, or 1; or
iv)

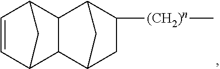

where n is from 1 to 10, or 1 to 8, or 1 to 6, or 1 to 4, or 1 to 2, or 1.
G3] The process of any one of B3]-F3] above, or the composition of any one of B3]-F3]above, wherein, for Formula 1, B is an alkyl, or a C1-C5 alkyl, or a C1-C4 alkyl, or a C1-C3 alkyl, or a C1-C2 alkyl, or methyl.
H3] The process of any one of B3]-G3] above, or composition of any one of B3]-G3]above, wherein, for Formula 1, C is an alkyl, or a C1-C5 alkyl, or a C1-C4 alkyl, or a C1-C3 alkyl, or a C1-C2 alkyl, or methyl.
I3] The process of any one of B3]-H3] above, or the composition of any one of B3]-H3]above, wherein, for Formula 1, E is an alkyl, or a C1-C5 alkyl, or a C1-C4 alkyl, or a C1-C3 alkyl, or a C1-C2 alkyl, or methyl.
J3] The process of any one of B3]-I3] above, or the composition of any one of B3]-I3]above, wherein, for Formula 1, F is an alkyl, or a C1-C5 alkyl, or a C1-C4 alkyl, or a C1-C3 alkyl, or a C1-C2 alkyl, or methyl.
K3] The process of any one of B3]-J3] above, or the composition of any one of B3]-J3]above, wherein, Formula 1 is selected from compounds s1) through s16):

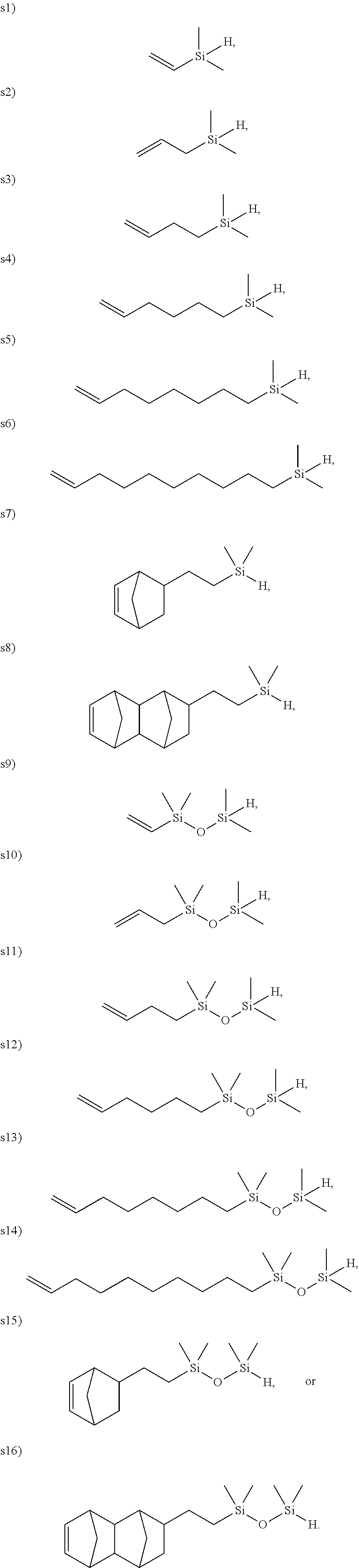

L3] The process of K3] above, or the composition of K3] above, wherein, Formula 1 is selected from compounds s1) through s8), as described above.
M3] The process of K3] above, or the composition of K3] above, wherein, Formula 1 is selected from compounds s9) through s16), as described above.
N3] The process of any one of B3]-K3] above, or the composition of any one of B3]-K3]above, wherein the silane monomer is selected from the following compounds: allyldimethylsilane, 3-butenyldimethyl-silane, 1-(but-3-en-1-yl)-1,1,3,3-tetramethyldisiloxane (BuMMH), 1-(hex-5-en-1-yl)-1,1,3,3-tetramethyldisiloxane (HexMMH), (2-bicyclo-[2.2.1]hept-5-en-2-yl)ethyl)dimethyl-silane (NorDMS) or 1-(2-bicyclo[2.2.1]hept-5-en-2-yl)ethyl)-1,1,3,3-tetramethyldisiloxane (NorMMH), or any combination thereof.
O3] The process of any one of A]-R] or A3]-N3] above, or the composition of any one of S], T]-J2] or A3]-N3] above, wherein the olefin/silane interpolymer of component a has a melting temperature (Tₘ)≥56° C., ≥58° C., ≥60° C., ≥61° C. and/or ≤85° C., or ≤80° C., or ≤75° C., or ≤70° C., or ≤65° C.
P3] The process of any one of A]-R] or A3]-03] above, or the composition of any one of S], T]-J2] or A3]-03] above, wherein the olefin/silane interpolymer of component a has a molecular weight distribution (MWD=Mw/Mn)≥1.5, or ≥1.6, or ≥1.7, or ≥1.8, or ≥1.9, or ≥2.0 and/or ≤5.0, or ≤4.5, or ≤4.0, or ≤3.5, or ≤3.0, or ≤2.9, or ≤2.8, or ≤2.7, or ≤2.6, or ≤2.5, or ≤2.4, or ≤2.3.
Q3] The process of any one of A]-R] or A3]-P3] above, or the composition of any one of S], T]-J2] or A3]-P3] above, wherein the olefin/silane interpolymer of component a has a number average molecular weight (Mn)≥10,000 g/mol, or ≥15,000 g/mol, or ≥20,000 g/mol, or ≥25,000 g/mol, or ≥30,000 g/mol, or ≥35,000 g/mol, or ≥40,000 g/mol and/or ≤100,000 g/mol, or ≤90,000 g/mol, or ≤80,000 g/mol, or ≤75,000 g/mol, or ≤70,000 g/mol, or ≤65,000 g/mol, or ≤60,000 g/mol, or ≤55,000 g/mol.
R3] The process of any one of A]-R] or A3]-Q3] above, or the composition of any one of S], T]-J2] or A3]-Q3] above, wherein the olefin/silane interpolymer of component a has a weight average molecular weight (Mw)≥20,000 g/mol, or ≥40,000 g/mol, or ≥60,000 g/mol, or ≥80,000 g/mol, or ≥90,000 g/mol and/or ≤300,000 g/mol, or ≤250,000 g/mol, or ≤200,000 g/mol, or ≤150,000 g/mol, or ≤120,000 g/mol, or ≤110,000 g/mol.
S3] The process of any one of A]-R] or A3]-R3] above, or composition of any one of S], T]-J2] or A3]-R3] above, wherein the weight ratio of component a to component b is ≥200, or ≥220, or ≥240, or ≥260, or ≥280, or ≥300 or ≥310, or ≥320 or ≥330.
T3] The process of any one of A]-R] or A3]-S3] above, or the composition of any one of S], T]-J2] or A3]-S3] above, wherein the weight ratio of component a to component b is ≤1000 or ≤900, or ≤800, or ≤780 or ≤760, or ≤740, or ≤720, or ≤700, or ≤680, or ≤670.
U3] The process of any one of A]-R] or A3]-T3] above, or the composition of any one of S], T]-J2] or A3]-T3] above, wherein the composition comprises component c (a filler), and further component c is present in an amount ≥30 wt %, ≥40 wt %, ≥50 wt %, or ≥60 wt %, or ≥70 wt %, based on the weight of the composition and/or ≤95 wt %, or ≤90 wt %, or ≤85 wt %, or ≤80 wt %, or ≤75 wt %, based on the weight of the composition. Further component c is selected from talc and/or carbon black.
V3] The process of any one of A]-R] or A3]-U3] above, or the composition of any one of S], T]-J2] or A3]-U3] above, wherein the composition comprises component d (a peroxide), and further component d is present in an amount ≥0.50 wt %, ≥1.0 wt %, ≥2.0 wt %, or ≥4.0 wt %, or ≥4.0 wt %, based on the weight of the composition and/or ≤7.0 wt %, or ≤6.5 wt %, or ≤6.0 wt %, or ≤5.5 wt %, or ≤5.0 wt %, based on the weight of the composition. Further component d is selected from a cyclic peroxide or a dialkyl, diaryl, dialkaryl, or diaralkyl peroxide, having the same or differing respective alkyl, aryl, alkaryl, or aralkyl moieties, and further each dialkyl, diaryl, dialkaryl, or diaralkyl peroxide, having the same respective alkyl, aryl, alkaryl, or aralkyl moieties.
W3] The process of any one of A]-R] or A3]-V3] above, or the composition of any one of S], T]-J2] or A3]-V3] above, wherein the composition comprises component e (a coagent), and further component e is present in an amount ≥0.05 wt %, ≥0.10 wt %, ≥0.20 wt %, or ≥0.50 wt %, or ≥1.0 wt %, based on the weight of the composition and/or ≤10 wt %, or ≤15 wt %, or ≤10 wt %, or ≤5.0 wt %, or ≤2.0 wt %, or ≤1.5 wt %, based on the weight of the composition. Further component e is selected from triallyl isocyanurate (TAIC), triallyl cyanurate (TAC), vinyl D4, vinyl D3, vinyl D5 or any combination thereof.
X3] The process of any one of A]-R] or A3]-W3] above, or the composition of any one of S], T]-J2] or A3]-W3] above, wherein the composition comprises component f (a processing aid), and further component f is present in an amount ≥0.05 wt %, ≥0.10 wt %, ≥0.20 wt %, or ≥0.50, based on the weight of the composition and/or ≤2.0 wt %, or ≤1.5 wt %, or ≤1.0 wt %, based on the weight of the composition. Further component f is selected from a fluoropolymer of a PDMS (for example, low, medium and high MW PDMS).
Y3] The process of any one of A]-R] or A3]-X3] above, or the composition of any one of S], T]-J2] or A3]-X3] above, wherein the composition comprises component g (an oil), and further component g is present in an amount ≥30 wt %, ≥40 wt %, ≥50 wt %, or ≥60 wt %, or ≥70 wt %, based on the weight of the composition and/or ≤95 wt %, or ≤90 wt %, or ≤85 wt %, or ≤80 wt %, or ≤75 wt %, based on the weight of the composition. Further component g is a mineral oil.
Z3] The process of any one of A]-R] or A3]-Y3] above, or the composition of any one of S], T]-J2] or A3]-Y3] above, wherein the composition comprises component h (a secondary anti-oxidant), and further component h is present in an amount ≥0.05 wt %, ≥0.10 wt %, ≥0.20 wt %, or ≥0.50 wt %, or ≥0.8 wt %, based on the weight of the composition and/or ≤4.0 wt %, or 2.0 wt %, or ≤1.5 wt %, or ≤1.0 wt %, based on the weight of the composition. Further component h is selected from a thioether and/or a phosphite, and further a thioether.
A4] The process of any one of A]-R] or A3]-Z3] above, or the composition of any one of S], T]-J2] or A3]-Z3] above, wherein component a is present in an amount ≥50.00 wt %, or ≥60.00 wt %, or ≥70.00 wt %, or ≥80.00 wt %, or ≥90.00 wt %, or ≥95.00 wt %, based on the weight of the composition and/or ≤99.90 wt %, or ≤99.88 wt %, or ≤99.86 wt %, based on the weight of the composition.
B4] The process of any one of A]-R] or A3]-A4] above, or the composition of any one of S], T]-J2] or A3]-A4] above, wherein component b is present in an amount ≥0.05 wt %, or ≥0.10 wt %, or ≥0.12 wt %, or ≥0.14 wt %, based on the weight of the composition and/or ≤1.0 wt %, or ≤0.70 wt %, or 0.50 wt %, or ≤0.40 wt %, or ≤0.35 wt %, based on the weight of the composition.
C4] The process of any one of A]-R] or A3]-B4] above, or the composition of any one of S], T]-J2] or A3]-B4] above, wherein the sum of component a and component b is present in an amount ≥50 wt %, or ≥60 wt %, or ≥70 wt %, or ≥75 wt %, or ≥80 wt %, or ≥85 wt %, or ≥90 wt %, or ≥95 wt %, based on the weight of the composition and/or ≤100 wt %, or ≤99 wt %, or ≤98 wt %, or ≤96 wt %, based on the weight of the composition.
D4] A blend composition comprising the composition of any one of S], T]-J2] or A3]-C4]above, and a thermoplastic polymer, different from the olefin/silane interpolymer of component a in one or more features, such as monomer(s) types, monomer(s) amounts, monomer(s) distributions, density, melt index (I2), Mn, Mw, MWD, or any combination thereof, and further, in one or more features, such as monomer(s) types, monomer(s) amounts, monomer(s) distributions, density, melt index (I2), or any combination thereof. In a further embodiment, the thermoplastic polymer is selected from an olefin-based polymer, further an ethylene-base polymer or a propylene-based polymer, further an ethylene-based polymer.
E4] A blend composition comprising the composition of any one of S], T]-J2] or A3]-D4]above, and an ethylene/alpha-olefin interpolymer or an ethylene/alpha-olefin copolymer; or an ethylene/alpha-olefin multi-block interpolymer, or an ethylene/alpha-olefin multi-block copolymer.
F4] A blend composition comprising the composition of any one of S], T]-J2] or A3]-E4]above, and a polymer selected from the following: an ethylene/propylene/nonconjugated diene interpolymer, an ethylene/alpha-olefin copolymer, an ethylene/alpha-olefin multi-block copolymer, a polyethylene homopolymer, a styrene/ethylene interpolymer (for example, a SEBS) or any combination thereof.
G4] The blend composition of E4] or F4] above, wherein the alpha-olefin of the ethylene/alpha-olefin interpolymer, and further copolymer, is a C3-C20 alpha-olefin, or a C3-C10 alpha-olefin, or a C3-C8 alpha-olefin, or one of propylene, 1-butene, 1-hexene or 1-octene, or one of propylene, 1-butene, or 1-octene, or one of 1-butene or 1-octene, or 1-octene.
H4] An article comprising at least one component formed from the composition of any one of S], T]-J2] or A3]-C4] above.
I4] An article comprising at least one component formed from the blend composition of any one of D4-G4] above.
J4] The article of H4] or I4] above, wherein the article is a foam or a TPV (thermoplastic vulcanizate).
K4] The article of H4] or I4] above, wherein the article is an automobile.
L4] The article of H4] or I4] above, wherein the article is a solar cell module, a wire or cable, a footwear component, an automotive part, a window profile, a tire, a tube, or a roofing membrane.

### Test Methods

### Gel Permeation Chromatography

The chromatographic system consisted of a PolymerChar GPC-IR (Valencia, Spain) high temperature GPC chromatograph, equipped with an internal IR5 infra-red detector (IR5). The autosampler oven compartment was set at 1600 Celsius, and the column compartment was set at 1500 Celsius. The columns were four AGILENT “Mixed A” 30 cm, 20-micron linear mixed-bed columns. The chromatographic solvent was 1,2,4-trichloro-benzene, which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed with 21 narrow molecular weight distribution polystyrene standards, with molecular weights ranging from 580 to 8,400,000, and which were arranged in six “cocktail” mixtures, with at least a decade of separation between individual molecular weights. The standards were purchased from Agilent Technologies. The polystyrene standards were prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards were dissolved at 80 degrees Celsius, with gentle agitation, for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1),

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects, such that linear homopolymer polyethylene standard is obtained at 120,000 Mw. The total plate count of the GPC column set was performed with decane (prepared at “0.04 g in 50 milliliters” of TCB, and dissolved for 20 minutes with gentle agitation.) The plate count (Equation 2) and symmetry (Equation 3) were measured on a 200 microliter injection according to the following equations:

$$Plate Count = 5.54 * {( \frac{( {RV}_{Peak Max}}{Peak Width at \frac{1}{2} height} )}^{2} , \qquad ( EQ2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - {RV}_{Peak max} )}{( {RV}_{Peak max} - Front Peak {RV}_{one tenth height} )} , \qquad ( EQ3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, wherein the samples were weight-targeted at “2 mg/ml,” and the solvent (contained 200 ppm BHT) was added to a pre nitrogen-sparged, septa-capped vial, via the PolymerChar high temperature autosampler. The samples were dissolved for two hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , \qquad ( EQ 5 )$$

$$and$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ 6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak were then assumed to be related to a linear-shift in flowrate (Flowrate(effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7: Flowrate(effective)=Flowrate(nominal)*(RV(FM Calibrated)/RV(FM Sample)) (EQ7). Processing of the flow marker peak was done via the PolymerChar GPCOne™ Software. Acceptable flowrate correction is such that the effective flowrate should be within +/−0.7% of the nominal flowrate.

### Melt Index

The melt index I2 of an ethylene-based polymer is measured in accordance with ASTM D-1238, condition 190° C./2.16 kg (melt index I10 at 190° C./10.0 kg). The I10/I2 was calculated from the ratio of I10 to the I2. The melt flow rate MFR of a propylene-based polymer is measured in accordance with ASTM D-1238, condition 230° C./2.16 kg.

### Density

ASTM D4703 was used to make a polymer plaque for density analysis. ASTM D792, Method B, was used to measure the density of each polymer.

### NMR Characterization of Terpolymers

For ¹³C NMR experiments, samples were dissolved, in 10 mm NMR tubes, in tetrachloroethane-d₂ (with or without 0.025 M Cr(acac)₃). The concentration was approximately 300 mg/2.8 mL. Each tube was then heated in a heating block set at 110° C. The sample tube was repeatedly vortexed and heated to achieve a homogeneous flowing fluid. The ¹³C NMR spectrum was taken on a BRUKER AVANCE 600 MHz spectrometer, equipped with a 10 mm C/H DUAL cryoprobe. The following acquisition parameters were used: 60 seconds relaxation delay, 90 degree pulse of 12.0 μs, 256 scans. The spectrum was centered at 100 ppm, with a spectral width of 250 ppm. All measurements were taken without sample spinning at 110° C. The ¹³C NMR spectrum was referenced to “74.5 ppm” for the resonance peak of the solvent. For a sample with Cr, the data was taken with a “7 seconds relaxation delay” and 1024 scans. The “mol % silane (silane monomer)” was calculated based on the integration of SiMe carbon resonances, versus the integration of CH2 carbons associated with ethylene units and CH/CH3 carbons associated with octene units. The “mol % octene (or other alpha-olefin)” was similarly calculated with reference to the CH/CH3 carbons associated with octene (or other alpha-olefin).

For ¹H NMR experiments, each sample was dissolved, in 8 mm NMR tubes, in tetrachloroethane-d₂ (with or without 0.001 M Cr(acac)₃). The concentration was approximately 100 mg/1.8 mL. Each tube was then heated in a heating block set at 110° C. The sample tube was repeatedly vortexed and heated to achieve a homogeneous flowing fluid. The ¹H NMR spectrum was taken on a BRUKER AVANCE 600 MHz spectrometer, equipped with a 10 mm C/H DUAL cryoprobe. A standard single pulse ¹H NMR experiment was performed. The following acquisition parameters were used: 70 seconds relaxation delay, 90 degree pulse of 17.2 μs, 32 scans. The spectrum was centered at 1.3 ppm, with a spectral width of 20 ppm. All measurements were taken, without sample spinning, at 110° C. The 1H NMR spectrum was referenced to “5.99 ppm” for the resonance peak of the solvent (residual protonated tetrachloroethane). For a sample with Cr, the data was taken with a “16 seconds relaxation delay” and 128 scans. The “mol % silane (silane monomer)” was calculated based on the integration of SiMe proton resonances, versus the integration of CH2 protons associated with ethylene units and CH3 protons associated with octene units.

### Differential Scanning Calorimetry (DSC)—Polymer

Differential Scanning Calorimetry (DSC) is used to measure Tm, Tc, Tg and crystallinity in ethylene-based (PE) polymer samples and propylene-based (PP) polymer samples. Each sample (0.5 g) was compression molded into a film, at 5000 psi, 190° C., for two minutes. About 5 to 8 mg of film sample was weighed and placed in a DSC pan. The lid was crimped on the pan to ensure a closed atmosphere. Unless otherwise stated, the sample pan was placed in a DSC cell, and then heated, at a rate of 10° C./min, to a temperature of 180° C. for PE (230° C. for PP). The sample was kept at this temperature for three minutes. Then the sample was cooled at a rate of 10° C./min to −90° C. for PE (−60° C. for PP), and kept isothermally at that temperature for three minutes. The sample was next heated at a rate of 10° C./min, until complete melting (second heat). Unless otherwise stated, melting point (Tm) and the glass transition temperature (Tg) of each polymer were determined from the second heat curve, and the crystallization temperature (Tc) was determined from the first cooling curve. The respective peak temperatures for the Tm and the Tc are typically recorded. The percent crystallinity can be calculated by dividing the heat of fusion (Hf), determined from the second heat curve, by a theoretical heat of fusion of 292 J/g for PE (165 J/g for PP), and multiplying this quantity by 100 (for example, % cryst.=(Hf/292 J/g)×100 (for PE)).

### Experimental

### Materials

Polymers are listed below, and anti-oxidants are listed in Table 1A. The chemical structures for the anti-oxidants are shown in Table 1B.
SiH POE D: an ethylene/octene/silane terpolymer, density=0.873 g/cc, 12=0.8 g/10 min, 1.5 wt % of HDMS;
SiH POE E: an ethylene/octene/silane terpolymer, density=0.870 g/cc, 12=0.8 g/10 min, 3.4 wt % of HDMS;
POE D: an ethylene/octene copolymer, density=0.871 g/cc, 12=1.2 g/10 min.

TABLE 1A
Anti-Oxidants

| AO | Struct. # | AO type | Manufacturer |
|---|---|---|---|
| IRGANOX 1076 | 27 | Hindered phenol | BASF |
| CYANOX 1790 | 40 | Hindered phenol | Solvay |
| DSTDP | | Thioether | Solvay |
| TBM-6 | 49 | Hindered phenol | SI Group |
| | | and thioether | |
| IRGANOX E201 | 50 | Hindered phenol | BASF |
| IRGANOX B225 | 28 (I 1010) | Blend of IRGNAOX | BASF |
| | | 1010 and IRGAFOS | |
| | | 168* | |
| IRGANOX 245 | 37 | Hindered phenol | BASF |
| IRGANOX 1010 | 28 | Hindered phenol | BASF |

*IRGAFOS 168 is a hydrolytically stable phosphite processing stabilizer (secondary antioxidant).

TABLE 1B
Anti-Oxidants

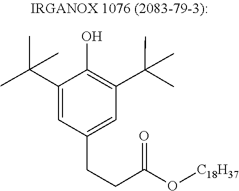

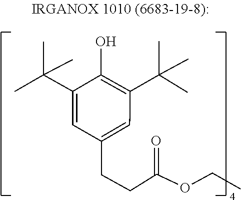

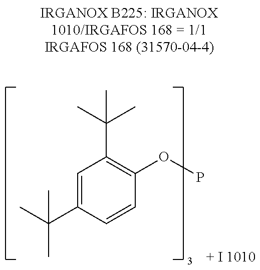

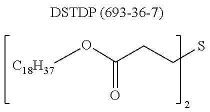

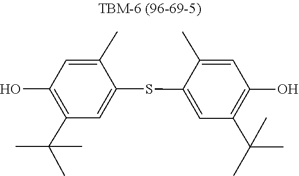 [SMILES: Cc1cc(O)c(C(C)(C)C)cc1Sc1cc(C(C)(C)C)c(O)cc1C]

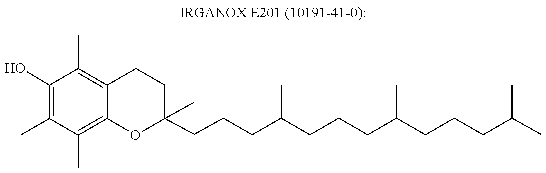 [SMILES: Cc1c(C)c2c(c(C)c1O)CCC(C)(CCCC(C)CCCC(C)CCCC(C)C)O2]

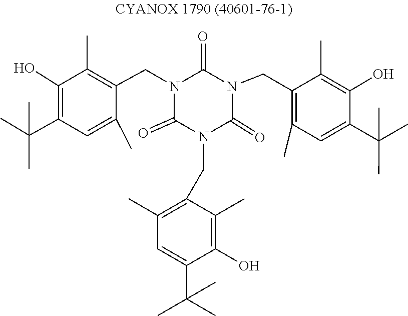 [SMILES: Cc1cc(C(C)(C)C)c(O)c(C)c1Cn1c(=O)n(Cc2c(C)cc(C(C)(C)C)c(O)c2C)c(=O)n(Cc2c(C)cc(C(C)(C)C)c(O)c2C)c1=O]

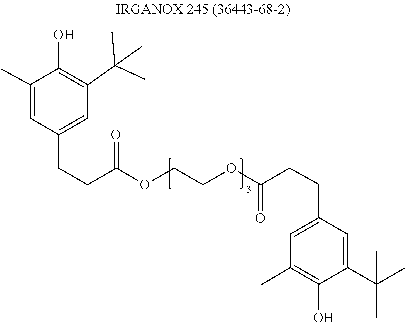

### Polymer Syntheses and Properties

The interpolymers (SiH-POE D and SiH-POE E and POE D) were each prepared in a one gallon polymerization reactor that was hydraulically full, and operated at steady state conditions. The solvent was ISOPAR-E, supplied by the ExxonMobil Chemical Company. The 5-hexenyldimethyl-silane (HDMS), supplied by Gelest, was used as a termonomer, and was purified over AZ-300 alumina supplied by UOP Honeywell prior to use. The HDMS was fed to the reactor as a 22 wt % solution in ISOPAR-E. The reactor temperature was measured at or near the exit of the reactor. The interpolymer was isolated and pelletized. Polymerization conditions are listed in Table 2B3-2D), and catalysts and co-catalysts are shown in Table 2A. The polymer properties of the ethylene/octene/silane interpolymers (SiH-POE D and SiH-POE E) and the ethylene/octene interpolymer (POE D) are shown in Tables 3A and 3B.

TABLE 2A
Catalysts and Co-catalysts

| | |
|---|---|
| Catalyst (CAT) | |
| PE CAT 2 (WO2012/027448) | 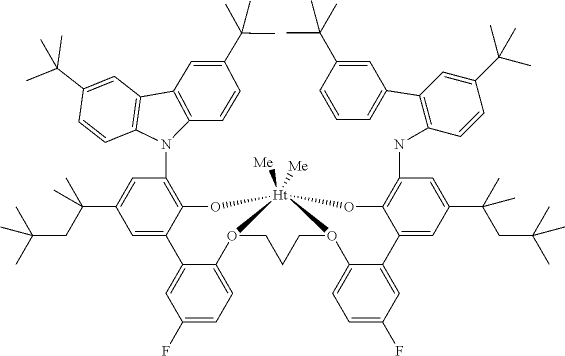 |
| Cocatalyst | |
| CoCAT-1 | A mixture of methyldi(C14-18 alkyl)ammonium salts of |
| | tetrakis(pentafluorophenyl)borate, prepared by reaction of a long chain trialkylamine |
| | (Armeen ™ M2HT, available from Akzo-Nobel, Inc.), HCl and Li[B(C6F5)4], |
| | substantially as disclosed in U.S. Pat. No. 5,919,983, Ex. 2 (no further purification performed) |
| | (Boulder Scientific) |
| CoCAT-2 | Modified methylalumoxane (MMAO) Type 3A (no further purification performed) |
| | (Akzo Nobel) |

TABLE 2B
Polymerization Conditions to Produce SiH-POE

| | Reactor | Reactor | | | | | | ethylene |
|---|---|---|---|---|---|---|---|---|
| | Temp., | Pressure, | Solvent, | Ethylene, | Octene, | HDMS, | Hydrogen, | conversion, |
| | ° C. | psig | lb/hr | lb/hr | lb/hr | lb/h | sccm | % |
| SiH- | 168 | 726 | 36 | 3.8 | 5 | 2.9 | 193 | 82 |
| POE E | | | | | | | | |
| SiH- | 170 | 729 | 38 | 3.8 | 5 | 1.4 | 192 | 83 |
| POE D | | | | | | | | |
| POE D | 170 | 728 | 39 | 3.8 | 5.4 | 0 | 162 | 83 |

TABLE 2C
Catalyst Feed Flows and Efficiency

| | | Catalyst | Catalyst | Overall Catalyst |
|---|---|---|---|---|
| | | Solution | Solution | Efficiency, (g |
| | | Flow, | Metal Conc., | interpolymer/g total |
| | Catalyst | lb/hr | ppm* | catalyst metal) |
| SiH-POE E | PE CAT 2 | 0.57 | 3.96 | 2,385,000 |
| SiH-POE D | PE CAT 2 | 0.33 | 3.96 | 3,911,000 |
| POE D | PE CAT 2 | 0.33 | 3.96 | 3,939,000 |

*The “ppm” amount based on the weight of the respective catalyst feed solution.

TABLE 2D
Cocatalyst Feed Flows

| | CoCAT 1 | CoCAT 1 | CoCAT 2 | CoCAT 2 |
|---|---|---|---|---|
| | Solution | Solution | Solution | Solution |
| | Flow, | Conc., | Flow, | Conc., |
| | lb/hr | ppm* | lb/hr | ppm Al** |
| SiH-POE E | 0.58 | 31.25 | 0.53 | 32.2 |
| SiH-POE D | 0.34 | 31.25 | 0.31 | 32.2 |
| POE D | 0.33 | 31.25 | 0.31 | 32.2 |

*The “ppm” amount based on the weight of the co-catalyst feed solution.
**The “ppm” amount of Al based on the weight of the co-catalyst feed solution.

TABLE 3A
Polymer Properties

| Polymer Description | | | | | Silane Information | | |
|---|---|---|---|---|---|---|---|
| | Density | MI (I2) | Octene | Tₘ | Silane | Silane | Silane |
| | (g/cc) | (dg/min) | (mol %) | (° C.) | Type | mol %* | wt %** |
| SiH- | 0.870 | 0.8 | 11.0 | 61.9 | HDMS | 0.9 | 3.4 |
| POE E | | | | | | | |
| SiH- | 0.873 | 0.8 | 11.0 | 64.5 | HDMS | 0.4 | 1.5 |
| POE D | | | | | | | |
| POE D | 0.871 | 1.2 | 12.0 | 61.9 | — | — | — |

*Mol % silane based on total moles of monomers in polymer, and determined by 1H NMR.
**Wt % silane calculated from the mol %, and based on the weight of the interpolymer.

TABLE 3B
Polymer Properties (Conventional GPC)

| | Mn (kg/mol) | Mw (kg/mol) | Mw/Mn |
|---|---|---|---|
| SiH-POE E | 45 | 100 | 2.2 |
| SiH-POE D | 49 | 108 | 2.2 |
| POE D | 52 | 112 | 2.2 |

### Composition Preparation

Polymer pellets were fed into Brabender mixing bowl, equipped with a 50 mL bowl and two roller rotors, set at 100° C. The pellets were mixed at 15 rpm for 5 minutes (ambient atmosphere) to melt the polymer. Then, the noted AO was added, and the final mixture was mixed at 50 rpm for 5 minutes, at ambient atmosphere. The polymer melt was discharged from Brabender, and compression molded at 100° C./10 MPa (2 minutes, mold temp.=melt temp. of composition) to make a “1 mm” thick plaque.

### Oxidative Induction Time (OIT) Analysis (DSC)

The Oxidation Induction Time (OIT), as carried out in a Differential Scanning calorimeter (DSC), is used to predict thermo-oxidative performance of a composition. A sample is heated up under a nitrogen atmosphere, typically to 200° C. Oxygen is then introduced to the sample cell, and the length of time before the onset of degradation—as seen by the initiation of an exothermic process in the DSC profile—is measured.

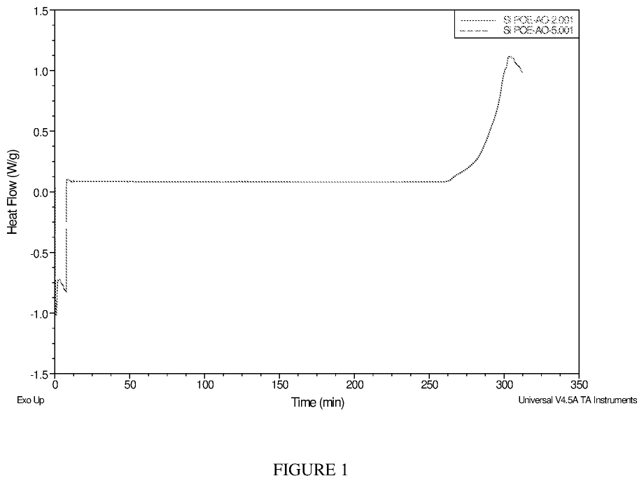

Each composition (about 5-10 mg of plaque) was weighed and placed in a DSC pan (DSC instrument Q2000 from TA Instrument). The lid was crimped on the pan to ensure a closed atmosphere. The OIT test was conducted as follows: 1) equilibrate at 50.0° C., under nitrogen atmosphere, 2) ramp 20.0° C./min to 200.0° C., under nitrogen atmosphere, 3) isothermal hold for 5.00 min at 200.0° C., under nitrogen atmosphere, 4) select gas as O2 (oxygen), 5) mark end of 5 min cycle, 6) isothermal hold for 300.00 min at 200.0° C., under oxygen atmosphere. Results are shown in Tables 4A and 4B. The OIT profiles for CE-3 (Si POE AO-2, upper profile, straight line) and for IE-2 (Si POE AO-5, lower profile, dashed line) are shown in FIG. 1.

As shown in Table 4A, the OIT of each inventive composition (IE-1-IE-4) was significantly longer than the corresponding comparative example (CE-2-CE-5). Both CE-1 and CE6, without any AO, oxidized and degraded immediately after switching the atmosphere from nitrogen to oxygen. The OIT value for each sample was zero. Similar results are seen in Table 4B. Inventive compositions IE-5 and IE-7 had very high “% Increase in OIT” values of 65.2% and 67.7%, respectively. It is believed that each inventive composition can act as an donor hydrogen (via the SiH) to recover the hindered phenol during oxidation processes, and thus, increase the OIT of the composition.

TABLE 4A
Compositions and OIT Results

| | CE-1 | CE-2 | CE-3 | CE-4 | CE-5 | CE-6 | IE-1 | IE-2 | IE-3 | IE-4 |
|---|---|---|---|---|---|---|---|---|---|---|
| POE D | 100 | 99.85 | 99.7 | 99.8 | 99.85 | | | | | |
| SiH-POE E | | | | | | 100 | 99.85 | 99.7 | 99.8 | 99.85 |
| IRGANOX 1076 | | 0.15 | | | | | 0.15 | | | |
| CYANOX 1790/ | | | 0.30 | | | | | 0.30 | | |
| DSTDP | | | | | | | | | | |
| TBM-6 | | | | 0.20 | | | | | 0.20 | |
| IRGANOX E201 | | | | | 0.15 | | | | | 0.15 |
| Total (wt. parts) | 100 | 100 | 100 | 100 | 100 | 100 | 100 | 100 | 100 | 100 |
| OIT* (minutes) | 0 | 28.5 | 250.2 | 72.8 | 29.6 | 0 | 34.1 | >302.5 | 81.9 | 43.3 |
| Increase in OIT | — | — | — | — | — | — | 19.6 | >20.9 | 12.5 | 46.3 |
| (%)** | | | | | | | | | | |

*OIT = the time before the onset of degradation − as seen by the initiation of an exothermic process in the DSC profile.
**% Increase in OIT = [(OIT (IE) − OIT (CE))/OIT (CE)] × 100; where “OIT (IE)” is the OIT value for the inventive composition and “(OIT (CE)” is the OIT value for the similar comparative composition.
Note,
IE-1 compared against CE-2, IE-2 compared against CE-3, IE-3 compared against CE-4 and IE-4 compared against CE-5.

TABLE 4B
Compositions and OIT Results

| | CE-7 | CE-8 | CE-9 | IE-5 | IE-6 | IE-7 | IE-8 | IE-9 | IE-10 |
|---|---|---|---|---|---|---|---|---|---|
| POE D | 99.9 | 99.8 | 99.85 | | | | | | |
| SIH-POE E | | | | 99.9 | 99.8 | 99.85 | | | |
| SIH-POE-D | | | | | | | 99.9 | 99.8 | 99.85 |
| IRGANOX 1010 | 0.1 | | | 0.1 | | | 0.1 | | |
| IRGANOX B225 | | 0.2 | | | 0.2 | | | 0.2 | |
| IRGANOX 245 | | | 0.15 | | | 0.15 | | | 0.15 |
| Total | 100 | 100 | 100 | 100 | 100 | 100 | 100 | 100 | 100 |
| OIT, min. | 53.4 | 95.8 | 67.8 | 88.2 | 106.4 | 113.7 | 58.2 | 102.1 | 72.2 |
| Increase in OIT (%) | | | | 65.2% | 11.1% | 67.7% | 9.0% | 6.6% | 6.5% |

Note,
IE-5 compared against CE-7, IE-6 compared against CE-8, IE-7 compared against CE-9, IE-8 compared against CE-7, IE-9 compared against CE-8 and IE-10 compared against CE-9.

1. A process to form a composition, the process comprising mixing at least the following components:
a) at least one olefin/silane interpolymer comprising at least one Si—H group, and
b) at least one hindered phenol selected from Formula H: 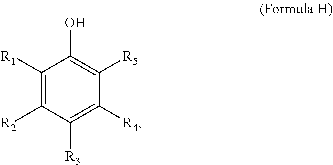
herein R1 is selected from H, a substituted or unsubstituted hydrocarbyl, or a substituted or unsubstituted heterohydrocarbyl; R2 is selected from H, a substituted or unsubstituted hydrocarbyl, or a substituted or unsubstituted heterohydrocarbyl; R3 is selected from H, a substituted or unsubstituted hydrocarbyl, or a substituted or unsubstituted heterohydrocarbyl; R4 is selected from H, a substituted or unsubstituted hydrocarbyl, or a substituted or unsubstituted heterohydrocarbyl; R5 is selected from H, a substituted or unsubstituted hydrocarbyl, or a substituted or unsubstituted heterohydrocarbyl; and R3 and R4 may optionally form a substituted or unsubstituted hydrocarbylene ring structure, or a substituted or unsubstituted heterohydrocarbylene ring structure; and R2 and R3 may optionally form a substituted or unsubstituted hydrocarbylene ring structure, or a substituted or unsubstituted heterohydrocarbylene ring structure; and wherein at least one of R1 and R5 is a substituted or unsubstituted hydrocarbyl, or a substituted or unsubstituted heterohydrocarbyl.

2. The process of claim 1, wherein the composition (C) has an increased Oxidative Induction Time (OIT), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “silane comprising at least one Si—H group,” and wherein the olefin-based polymer has a density that is within ±0.005 g/cc of the density of the interpolymer of component a, and has a melt index (I2) that is within ±0.5 g/10 min of the melt index of the interpolymer of component a; and wherein the OIT is determined by DSC.

3. The process of claim 2, wherein the composition (C) has an increase in OIT that is ≥5.0% greater than OIT of the similar composition (SC), as determined from the following Equation Y: Increase in OIT (%)=[(OIT(C)−OIT(SC))/OIT(SC)]×100; where OIT(C) is the OIT value for the composition and OIT(SC) is the OIT value for the similar composition.

4. The process of claim 1, wherein, for Formula H, R1 and R5 are each, independently, selected from H, alkyl, substituted alkyl, —CH₂—S-alkyl, —CH₂-phenol, —CH₂-substituted phenol; benzotriazol, substituted benzotriazol, —O-alkyl, or O-substituted alkyl.

5. The process of claim 1, wherein the olefin/silane interpolymer of component a is an ethylene/alpha-olefin/silane interpolymer.

6. The process of claim 1, wherein the olefin/silane interpolymer of component a has a density from 0.855 g/cc to 0.920 g/cc.

7. The process of claim 1, wherein the olefin/silane interpolymer of component a has a melt index (I2) from 0.5 g/10 min to 100 g/10 min.

8. The process of claim 1, wherein the process further comprises thermally treating the components during the mixing, at a temperature from 40° C. to 190° C.

9. A composition formed by the process of claim 1.

10. A composition comprising at least the following components:
a) at least one olefin/silane interpolymer comprising at least one Si—H group, and
b) at least one hindered phenol selected from Formula H: 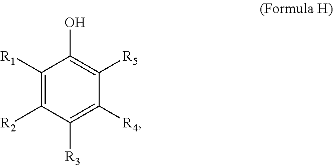
wherein R1 is selected from H, a substituted or unsubstituted hydrocarbyl, or a substituted or unsubstituted heterohydrocarbyl; R2 is selected from H, a substituted or unsubstituted hydrocarbyl, or a substituted or unsubstituted heterohydrocarbyl; R3 is selected from H, a substituted or unsubstituted hydrocarbyl, or a substituted or unsubstituted heterohydrocarbyl; R4 is selected from H, a substituted or unsubstituted hydrocarbyl, or a substituted or unsubstituted heterohydrocarbyl; R5 is selected from H, a substituted or unsubstituted hydrocarbyl, or a substituted or unsubstituted heterohydrocarbyl; and R3 and R4 may optionally form a substituted or unsubstituted hydrocarbylene ring structure, or a substituted or unsubstituted heterohydrocarbylene ring structure; and R2 and R3 may optionally form a substituted or unsubstituted hydrocarbylene ring structure, or a substituted or unsubstituted heterohydrocarbylene ring structure; and wherein at least one of R1 and R5 is a substituted or unsubstituted hydrocarbyl, or a substituted or unsubstituted heterohydrocarbyl.

11. The composition of claim 10, wherein, for Formula H, R1 and R5 are each, independently, selected from H, alkyl, —CH₂—S-alkyl, —CH₂-phenol, —CH₂-substituted phenol; benzotriazol, substituted benzotriazole, —O-alkyl, or O-substituted alkyl.

12. The composition of claim 10, wherein the olefin/silane interpolymer of component a is an ethylene/alpha-olefin/silane interpolymer.

13. The composition of claim 10, wherein the olefin/silane interpolymer of component a comprises, in polymerized form, from 0.10 wt % to 40 wt % of the silane, based on the weight of the interpolymer.

14. The composition of claim 10, wherein the olefin/silane interpolymer of component a has a density from 0.855 g/cc to 0.920 g/cc.

15. The composition of claim 10, wherein the olefin/silane interpolymer of component a has a melt index (I2) from 0.5 g/10 min to 100 g/10 min.

16. The composition of claim 10, wherein the weight ratio of component a to component b is from 200 to 1000.

17. The composition of claim 10, wherein the composition (C) has an increased Oxidative Induction Time (OIT), as compared to a similar composition (SC) that comprises the same components, except that the olefin/silane interpolymer of component a is replaced with a similar olefin-based polymer that contains the same monomer types as the interpolymer of component a, except the olefin-based polymer does not contain the “silane comprising at least one Si—H group,” and wherein the olefin-based polymer has a density that is within ±0.005 g/cc of the density of the interpolymer of component a, and has a melt index (I2) that is within ±0.5 g/10 min of the melt index of the interpolymer of component a; and wherein the OIT is determined by DSC.

18. The composition of claim 17, wherein the composition © has an increase in OIT that is ≥5.0% greater than OIT of the similar composition (SC), as determined from the following Equation Y: Increase in OIT (%)=[(OIT©−OIT(SC))/OIT(SC)]×100; where OIT(C) is the OIT value for the composition and OIT(SC) is the OIT value for the similar composition.

19. A blend composition comprising the composition of claim 10 and a thermoplastic polymer different from the olefin/silane interpolymer of component a in one or more of the following features: monomer(s) types, monomer(s) amounts, monomer(s) distributions, density, melt index (I2), Mn, Mw, MWD, or any combination thereof.

20. An article comprising at least one component formed from the composition of claim 9.
